(19) United States
(12) Patent Application Publication
(10) Pub. No.: US 2013/0208494 A1
(43) Pub. Date: Aug. 15, 2013

(54) EMERGENCY VEHICLE LIGHTING APPARATUS INCLUDING A LIGHT BAR THAT CAN BE RAISED TO INCREASE VISIBILITY DURING AN EMERGENCY

(71) Applicant: Russell C. Jones, Fulton, MO (US)

(72) Inventor: Russell C. Jones, Fulton, MO (US)

(21) Appl. No.: 13/372,626

(22) Filed: Feb. 14, 2012

(51) Int. Cl. F21V 21/14

(52) U.S. Cl. 362/526; 362/523

(57) ABSTRACT

A linearly actuated lightbar system elevates an emergency lightbar several feet above the cab or other highest point of a vehicle to provide the earliest possible notification to other drivers as to the presence of a service or emergency vehicle, and to the possible existence of a dangerous situation that requires other drivers to slow down and be more attentive. By raising the lightbar well-above the cab of the vehicle, conditions such as obstructions and topographic characteristics can be overcome that might otherwise delay such notification. The lightbar can then be lowered back to a more typical height for safe travel once the vehicle is ready to leave. A linear actuator is provided to raise and lower the lightbar that can be hydraulic, pneumatic, or mechanical. The system can be coupled to a frame for rigidly coupling the system to the bed, or other stable structure of the vehicle.

### FIELD OF THE INVENTION

This application relates generally to warning/emergency lighting for vehicles, and in particular to vehicle lightbars.

### BACKGROUND OF THE INVENTION

Emergency and service response vehicles such as police vehicles, fire engine trucks, ambulances, tow trucks, and the like, are regularly dispatched to render aid in various accidents and traffic situations. These situations often require the emergency and service vehicles to stop in or very near roadways, over which other vehicles are traveling at high rates of speed and/or where visibility of stopped vehicles is often impaired. Such necessary slowdowns for roadway emergencies or other problems can often lead to additional accidents when the regular flow of traffic is interrupted. Indeed, many roadway service and emergency workers, such as tow truck or wrecker drivers, highway workers, police officers, firemen, and medical personnel, are injured or killed each year by unaware motorists, or motorists who did not receive sufficient advance warning of the dangerous conditions ahead.

Thus, it is essential that such vehicles identify their presence to other motorists as soon as possible. The earlier motorists become aware of a potential danger or hazard in the roadway ahead, the sooner the motorist can reduce speed and increase their attentiveness. To announce their presence and to warn others of an existing hazard or emergency, emergency vehicles typically employ emergency lights of various configurations to warn motorists of the danger and to indicate the need for traffic to slow down and/or to direct traffic away from the situation. One commonly employed light configuration for emergency and service vehicles is in the form of a lightbar. Lightbars come in many different designs and colors. Regardless of the type of vehicle or the agency for which it has been dispatched, the common purpose of their emergency lighting systems is to provide the earliest possible visual notice to other drivers of the presence of the vehicle and/or the existence of a potentially dangerous emergency situation.

Notwithstanding the foregoing goal, the ability to perceive common configurations of emergency vehicle lighting at the earliest possible moment can often be thwarted by the topographic features of the surrounding terrain as well as obstacles in or around roadways. For example, if the terrain is hilly and the emergency is one that lies on the downward side of the top of a hill, a driver climbing the front side of that hill may not see the emergency vehicle lighting until the driver has crested the hill at highway speed. This can severely limit the driver's ability to react to avoid the danger. Obstacles such as overpasses, bridges, signs, berms and the like can also obscure a driver's view of the lights until the driver's ability to properly react has been severely impaired. In fact, some emergency vehicles can partially or completely obstruct their own emergency lights when being operated for their intended purpose. For example, when a tow truck picks up a vehicle on a roadway, the lightbar on the tow truck can often be obscured to motorists approaching the tow truck from behind by the vehicle being loaded or towed.

Typically, externally mounted lightbar installations are configured and integrated with a vehicle to be reasonably aerodynamic. Thus, they are typically mounted close to, if not directly in contact with, the roof of the vehicle's cab or its highest point of extension. Permanently installing the light bars at a position that is higher above the cab of the emergency vehicle is not a practical solution because the higher the lights are extended, the more prone they will be to being ripped from the vehicle by high wind speeds, except at the slowest of vehicular speeds. Even if such elevated assemblies could be reinforced to remain coupled to the roof notwithstanding shearing forces applied to the lightbar while moving through the air at practical driving speeds, a reinforced elevated lightbar would add an unacceptable element of vehicular instability.

### SUMMARY OF THE INVENTION

A linearly actuated elevatable/lowerable lightbar system for vehicles allows a lightbar assembly, capable of providing emergency and/or warning lights for emergency or other vehicles often required to be parked in or near highways, to be elevated well-above the height at which lightbars are conventionally mounted. This increases the visibility of the warning lights to permit other travelers on a highway to become aware of the presence of an emergency or otherwise hazardous condition much sooner than otherwise, thereby increasing the time the travelers have to slow down and become more cautious and aware of the situation. The system then permits the lightbar assembly to be lowered back to a more conventional height so as to reduce air resistance and thereby enable safe travel at highway speeds.

One general aspect of the invention is a linearly actuated elevatable/lowerable lightbar system for vehicles. The system includes: a lightbar assembly; a linear actuating means for elevating the light bar assembly, and for lowering the light bar assembly once elevated. The linear actuating means includes: at least one rod having a first end coupled to the light bar assembly, and having a second end; and a controlling means for exerting an elevating force on the second end of the at least one rod to elevate the at least one rod and the lightbar assembly coupled thereto, the controlling means being further for removing the elevating force so as to lower the at least one rod and thereby lower the light bar assembly coupled thereto.

In some embodiments, the system further includes: a frame for rigidly supporting the lightbar system at a first end of the frame, the frame capable of being supportably secured to a vehicle at a second end of the frame. In some embodiments, the frame has a base at the second end that is capable of being secured to a bed of the vehicle.

In some embodiments, the linear actuating means is a fluid actuator. In some further embodiments, the fluid actuator includes a hydraulic cylinder, and the controlling means includes a hydraulic pump. In some further embodiments, the fluid actuator is a pneumatic cylinder and the controlling means includes an air compressor. In some further embodiments, the fluid actuator is a double action actuator. In some further embodiments, the system further includes a contact sensor to indicate whether the lightbar assembly is in an elevated position.

In some embodiments, the linear actuating means is a mechanical actuator. In some further embodiments, the mechanical actuator is a set screw and the controlling means includes an electric motor.

Another general aspect of the invention is a linearly actuated elevatable/lowerable lightbar system for vehicles, where the system includes: a lightbar assembly; a fluid actuator capable of elevating and lowering the light bar assembly, the fluid actuator having at least one rod having a first end coupled to the light bar assembly, and having a second end; a fluid controller capable of exerting an elevating force on the second end of the at least one rod to elevate the at least one rod and the lightbar assembly attached thereto, the fluid controller being further capable of removing the extending force to lower the at least one rod so as to lower the light bar assembly once extended; and a frame for rigidly supporting the lightbar system attached at a first end of the frame, the frame having a second end capable of being supportably secured to a vehicle.

In some embodiments, the second end of the frame has a base that is capable of being secured to a bed of the vehicle.

In some embodiments, the fluid actuator is a hydraulic cylinder and the fluid controller includes a hydraulic pump.

In some embodiments, the fluid actuator is a double acting hydraulic cylinder.

In some embodiments, the system further includes a contact sensor to indicate whether the lightbar assembly is in an elevated position. In further embodiments, the system also includes a control panel for controlling how far the lightbar assembly is elevated, and for controlling functioning of the lightbar assembly.

In some embodiments, the system also includes an operator warning indicator located in the control panel that receives a signal from the contact sensor when the lightbar is in an elevated position.

In some embodiments, the frame supportably couples the lightbar assembly to at least one vehicle frame rail.

In some embodiments, the frame is configured to mount the lightbar assembly between the cab and the bed of a vehicle.

In some embodiments, the system also includes a mechanical actuator coupled to the lightbar assembly that can be used to raise and lower the lightbar assembly if the fluid actuator and/or the fluid controller fails.

### BRIEF DESCRIPTION OF THE DRAWINGS

The following description can be better understood in light of Figures, in which:

FIG. 1 is an illustration of an embodiment of a elevatable lightbar assembly and linear actuator;

FIG. 2 is an illustration of the embodiment of a elevatable lightbar of FIG. 1 mounted on a support frame;

FIG. 3A is an illustration of the embodiment of the elevatable lightbar and support frame of FIG. 2 mounted on a large tow truck/wrecker, the view being from the rear of the tow truck/wrecker with the light bar elevated;

FIG. 3B is an illustration of the embodiment of the elevatable lightbar and support frame of FIG. 2 mounted on a large tow truck/wrecker, the view being from the rear of the tow truck/wrecker with the light bar fully lowered;

FIG. 3C is an illustration of the embodiment of the elevatable lightbar and support frame of FIG. 2 mounted on a large tow truck/wrecker, the view being from the side of the tow truck/wrecker and with the light bar elevated;

FIG. 3D is an illustration of the embodiment of the elevatable lightbar and support frame of FIG. 2 mounted on a large tow truck/wrecker, the view being from the side of the tow truck/wrecker with the light bar fully lowered;

FIG. 4A is an illustration of the embodiment of the elevatable lightbar and support frame of FIG. 2 mounted on a large flatbed wrecker, the view being from the side of the wrecker and with the light bar elevated;

FIG. 4B is an illustration of the embodiment of the elevatable lightbar and support frame of FIG. 2 mounted on a large flatbed wrecker, the view being from the side of the wrecker with the light bar fully lowered;

FIG. 5A is an illustration of the embodiment of the elevatable lightbar and support frame of FIG. 2 mounted within the cab of a pickup truck, the view being from behind the pickup truck and with the light bar elevated; and

FIG. 5B is an illustration of the embodiment of the elevatable lightbar and support frame of FIG. 2 mounted within the cab of a pickup truck, the view being from behind the pickup truck and with the light bar lowered.

### DETAILED DESCRIPTION

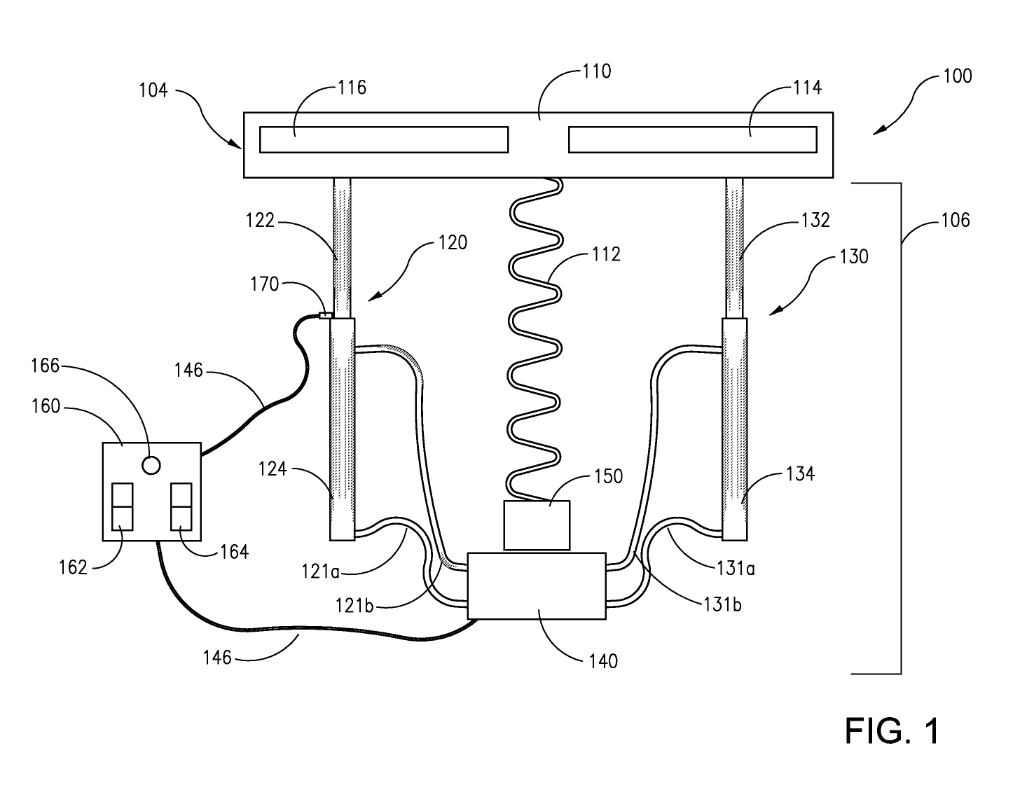

An illustration of an embodiment of the linearly actuated elevatable lightbar system 100 of the invention is shown in FIG. 1. In an embodiment, an external mount lightbar assembly 104 can be elevated to a height well-above the cab of a vehicle (not shown) while the vehicle is relatively stationary. The elevation of the lightbar assembly 104 is accomplished using a linear actuating means 106. The lightbar assembly 104 can, from the extended position, be lowered back to a standard height (typically close to or flush with the top of the cab) using the linear actuating means 106 so that the vehicle may once again travel safely at highway speeds. The linear actuating means 106 can be fluid actuated, such as hydraulically or pneumatically. In the alternative, the linear actuating means 106 can be mechanically actuated, such as for example by manipulating a set screw either by way of an electric motor or manually, or through use of a scissor-lift arrangement. Details of various embodiments of the linear actuating means 106 will be discussed in further detail below.

Those of skill in the art will recognize that there are a myriad of commercially available external mount light bar assemblies 104 of various designs on the market. The present invention can be easily adapted to function with virtually any of such commercially available designs. As illustrated by FIG. 1, a light bar assembly 104 may include a lightbar support mount housing 110 that supports and/or houses one or more light bars (e.g. 114, 116). Light bars 114, 116 can contain any number of lights of various colors, and they can be of various types including incandescent, halogen, and Light Emitting Diodes (LEDs). They can be made to create patterns of light using several techniques, including various flashing patterns, or the lights can be mechanically manipulated by rotating, rolling or otherwise moving the lights.

In an embodiment, a lightbar cable 112 is shown coupling an electrical source 150 to lightbars 114, 116 so as to supply the necessary power to illuminate and operate the lightbars 114, 116. Electrical source 150 can be a vehicle's battery coupled through the vehicle's electrical system, or it can be a separate power supply (such as a battery) dedicated to supplying power to the lightbars 114, 116. Lightbar support housing 110 may also provide a junction box or connection point (not shown) to provide a single connection between lightbar connection cable 112 and lightbars 114, 116, and any other devices mounted to lightbar support housing 110. Some lightbar designs do not require an external lightbar connection cable 112 to an external power source 150 in the manner illustrated in FIG. 1. Lightbars using light-emitting diodes (LED), for example, require very little power to operate and can be supplied with power using, for example, a lithium battery that is small enough to be proximately located with the lightbars 114, 116 themselves, such as within the support mount housing 110.

In a fluid actuated embodiment of linear actuating means 106, lightbar support housing 110 is coupled to and supported by two fluid actuators 120, 130, which can be either hydraulic or pneumatic actuators such as single or double acting cylinders. Each of fluid actuators 120, 130 can include a rod (122, 132), having one end coupled to the lightbar support housing 110 and the other end disposed within a cylinder (124, 134). Fluid actuators 120, 130 may be formed of steel, aluminum, or any other material suitable to raise and support lightbar assembly 104 and all of its components, including lightbar support housing 110, lightbars 114, 116 and any other objects mounted thereto. Moreover, those of skill in the art will recognize that fluid actuators 120, 130 can be scaled in diameter and length as appropriate in relation to the size and weight of the lightbar assembly that is to be actuated and the height to be attained. In some embodiments, a single fluid actuator may be used to raise and lower lightbar assembly 104. In such embodiments, one or more telescoping supports may be provided to help keep lightbar assembly 104 in a desired orientation.

Fluid controller 140 may include a hydraulic pump (for providing a liquid such as oil to the fluid actuators 120, 130) or a pneumatic air compressor (for providing compressed air to the fluid actuators 120, 130). As will be known to those of skill in the art, double acting fluid actuators 120, 130 may be operably connected to fluid controller 140 with fluid lines 121a,b and 131a,b respectively to control a double acting cylinder. To raise the lightbar assembly, lines 121a, 131a supply fluid under pressure from fluid controller 140 to the cylinders 124, 134 respectively, thereby creating a force at the end of a piston disposed within the cylinders (not shown) by which to extend rods 122, 132 upwardly in the cylinder. Likewise, to lower the lightbar assembly, fluid controller 140 supplies fluid under pressure to the opposite end of the piston through lines 121b, 131b to create a downward force by which the piston is forced back down inside the cylinders 124, 134 thereby forcing the fluid at the opposite end of the piston back through lines 121a, 131a to fluid controller 140 and allowing rods 122, 132 to retract. This fluid will be forced back through lines 121b, 131b to fluid controller 140 when the lightbar assembly 104 is raised again.

Those of skill in the art will recognize that when the lightbar assembly 104 has sufficient weight, a single acting cylinder can be used where by the fluid controller 140 can simply remove the pressure on the fluid supplied through lines 121a, 131a, and the weight of the lightbar assembly 104 will force the fluid from the cylinders 124, 134, thereby allowing the rods 122, 132 to retract and the lightbar assembly 104 to be lowered.

Fluid controller 140 may be located anywhere on a vehicle, and may even be a fluid controller for a hydraulic or pneumatic system already installed on the vehicle for other purposes. For example, a backhoe working on a road project may have a lightbar to warn workers or motorists of the backhoe's presence. Fluid actuators 120, 130 may be connected to existing auxiliary hydraulic connections used to control the shovel on the backhoe and can be controlled using the built-in auxiliary controls of the backhoe.

As previously mentioned, the linear actuating means 106 can include linear actuators 120, 130 that are raised and lowered mechanically, for example, by way of a threaded set screw (not shown) that when rotated in one direction applies force to the base of the rods 122, 132 as the screw extends in one direction, which in turn extends the rods 122, 132 upwardly thereby raising the lightbar assembly attached thereto. When rotated in the opposite direction, the set screw retracts and thus permits the rods 122, 132 to retreat, thereby lowering the light bar assembly. The screw can be turned using an electric motor driven by power source and controller 150, or it can be manually turned using, for example, a hand crank that is coupled thereto.

In other embodiments of the actuating means 106, such a mechanical actuation design can also be incorporated as part of an embodiment that includes a fluid actuation technique to offer redundancy should the fluid actuation means of the system fail. The mechanical system could still be operated manually to raise and lower the lightbar assembly in the event of a total fluid system failure.

Power source and controller 150 may be operably coupled to fluid controller 140, control panel 160, lightbars 114, 116, and any other electrically controlled devices of the system of the invention. Power source and controller 150 may be located in any convenient location on a vehicle having elevatable lightbar assembly 100 installed thereon. Electrical controller 150 may also be located within control panel 160 in some embodiments.

In an embodiment, control panel 160 may include a vertical height control switch 162, lightbar operation switch 164, and elevation warning light 166. Control panel 160 may be located in a cab of a vehicle having an embodiment of the elevatable lightbar assembly 100 installed on the vehicle, or it may be located on a support frame 200 in other embodiments. Lightbar operation switch 164 may be multiple switches, or may have multiple settings, depending on the type of lightbar used.

Vertical height control switch 162 may be used to operate fluid controller 140 to extend rods 122, 132 out of cylinders 124, 134 and vertically extend lightbar assembly 104 and its lightbars 114, 116 to a desired height. In some embodiments, a single touch of vertical height control switch 162 will automatically extend rods 122, 132 to a predetermined operating height. For example, there might be a predetermined medium extension level and/or a maximum extension level. In other embodiments, the height may be controlled by holding vertical height control switch 162 until the desired height of lightbar assembly 104 is achieved, thereby permitting a degree of extension between fully lowered and a predetermined maximum elevation. Internal sensors (not shown) may be used in conjunction with fluid controller 140 to ensure that the maximum level of elevation is not exceeded.

Elevation warning light 166 may be operably coupled to a contact sensor 170 to provide a visual warning and reminder that lightbar assembly 104 is in an elevated position and thus the vehicle should not be driven at any other than very slow speeds if at all. For example, lightbar assembly 104 may be elevated to such a height that it may be damaged or destroyed if the vehicle exceeds a certain speed. Similarly, lightbar assembly 104 may be elevated too high for overpasses, power lines, or trees in certain areas, thus requiring lightbar assembly 104 to be lowered to cab height before driving or maneuvering the vehicle. Contact sensor 170 may send a signal to elevation warning light 166 when the lightbar assembly is raised above cab height and is no longer in contact with the tops of the cylinders 124, 134. In some embodiments, contact sensor 170 may be a position sensor, limit switch, etc. Similarly, elevation warning light 166 may be a position indicator capable of conveying the extent to which lightbar assembly 104 has been raised above the cab of the vehicle. Other warning mechanisms may also be employed, including audio warnings, to remind the operator of the vehicle that the lightbar assembly 104 has not yet been fully lowered.

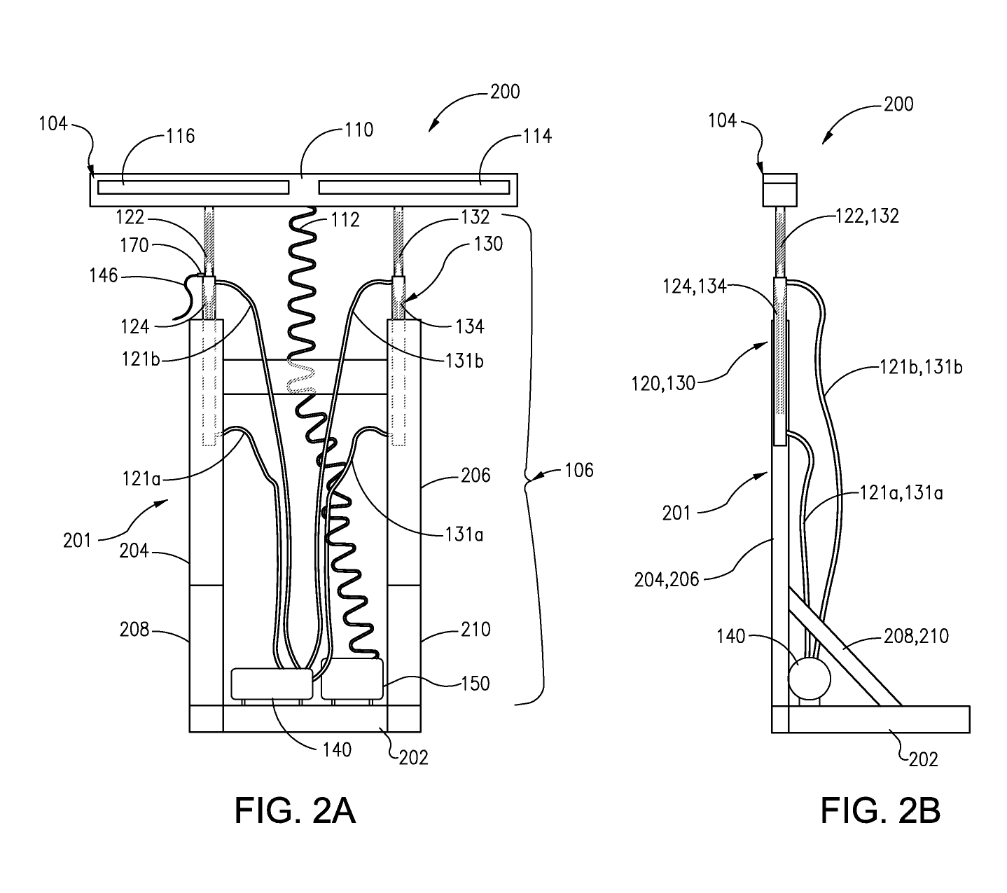

FIG. 2A illustrates a front view of an embodiment 200 of the linearly actuated elevatable lightbar system 100 of the invention as shown in FIG. 1, installed on a support frame 201. In an embodiment, support frame 201 includes two vertical members 204, 206 that support the cylinders 124, 134 of fluid actuators 130, 134 respectively, which in turn provides structural support for the lightbar assembly 104. To provide additional support against rotation of the system 100, the frame 201 includes a base 202 with cross-members 208, 210 as illustrated FIG. 2B, which shows a side view of the embodiment 200 of FIG. 2A. In an embodiment, fluid controller 140 and power source 150 are supported by base 202. As previously mentioned, they can be located anywhere on the vehicle that reasonably permits them to be coupled to the fluid actuators 130, 134. As illustrated, cylinders 124, 134 can be disposed and secured inside of the vertical members 204, 206 to ensure stability of the system, particularly when in the fully elevated position.

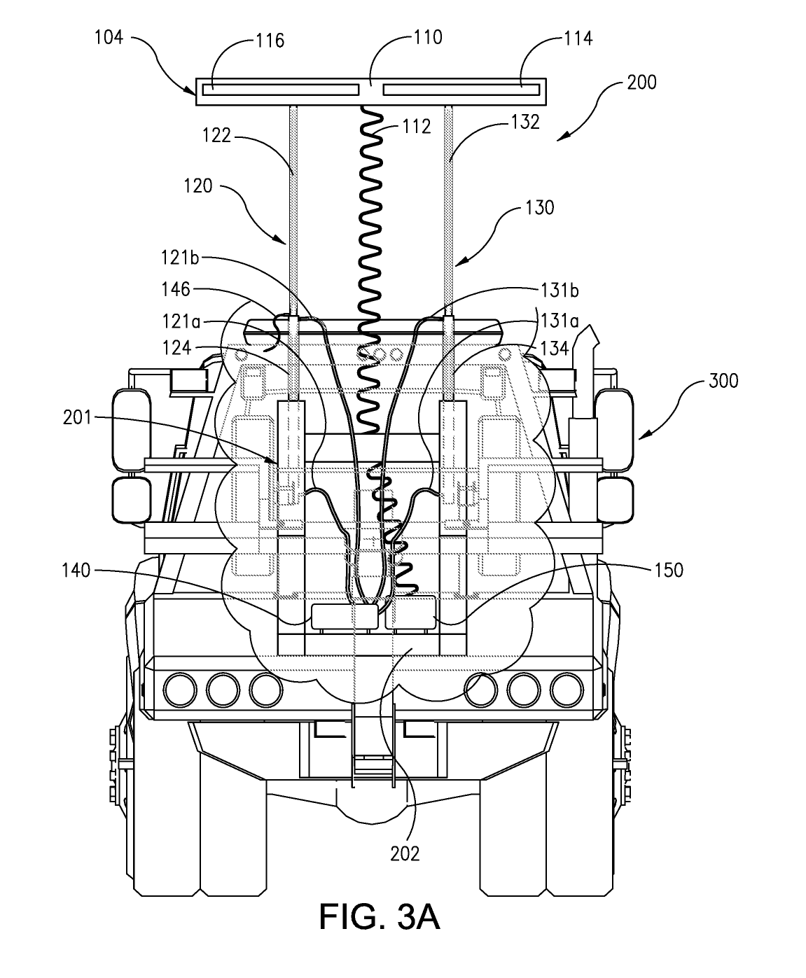

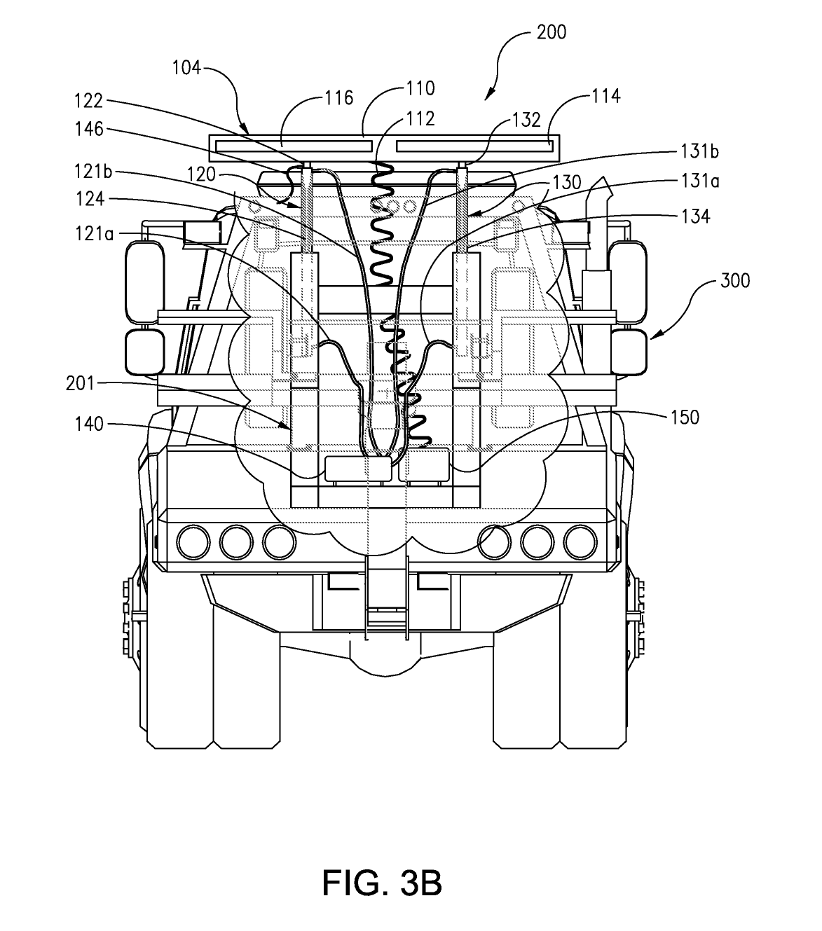

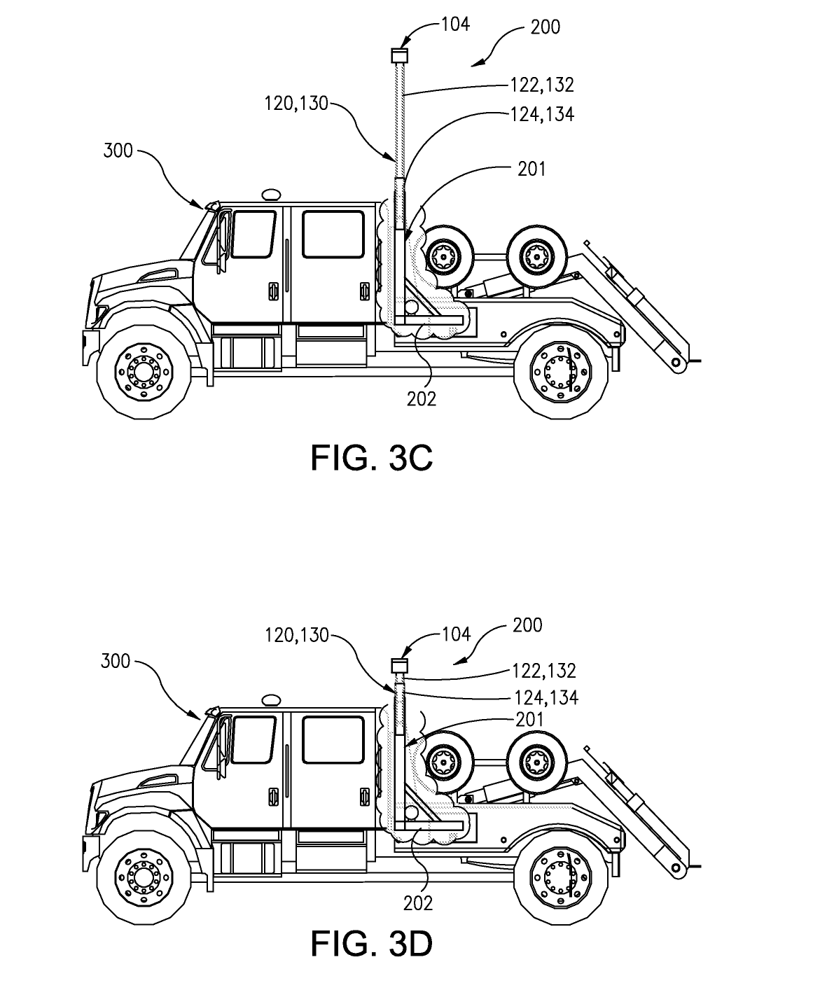

FIGS. 3A and 3B illustrate a view from the rear of a large tow truck/wrecker 300 having the embodiment 200 as illustrated in FIGS. 2A and 2B installed thereon, with the system in an raised state and lowered state respectively. A window is opened in the towing infrastructure to reveal the details of the embodiment 200 so that they can be more easily seen. The frame 201 of embodiment 200 can be bolted to the truck/wrecker 300 wherever convenient. For example, the base 202 can be bolted to the same bed of the truck/wrecker 300 that is used to support the towing apparatus. The embodiment 200 can be located directly behind the cab such as between the cab and the towing apparatus. To further ensure stability of the system 200, the vertical members 204, 206 of frame 201 could be bolted, screwed or otherwise secured to a vertical structure of the tow truck/wrecker 300, such as the cab or for example, a vertical structure that is used to isolate the towing equipment from the cab of the tow truck/wrecker 300. Those of skill in the art will recognize that the embodiment of the system 200, including frame 201, can be installed anywhere on the bed of the truck/wrecker 300 as is convenient and space allows.

FIGS. 3C and 3D illustrate tow truck/wrecker 300 from the side with the system 200 in the fully elevated and fully lowered positions respectfully.

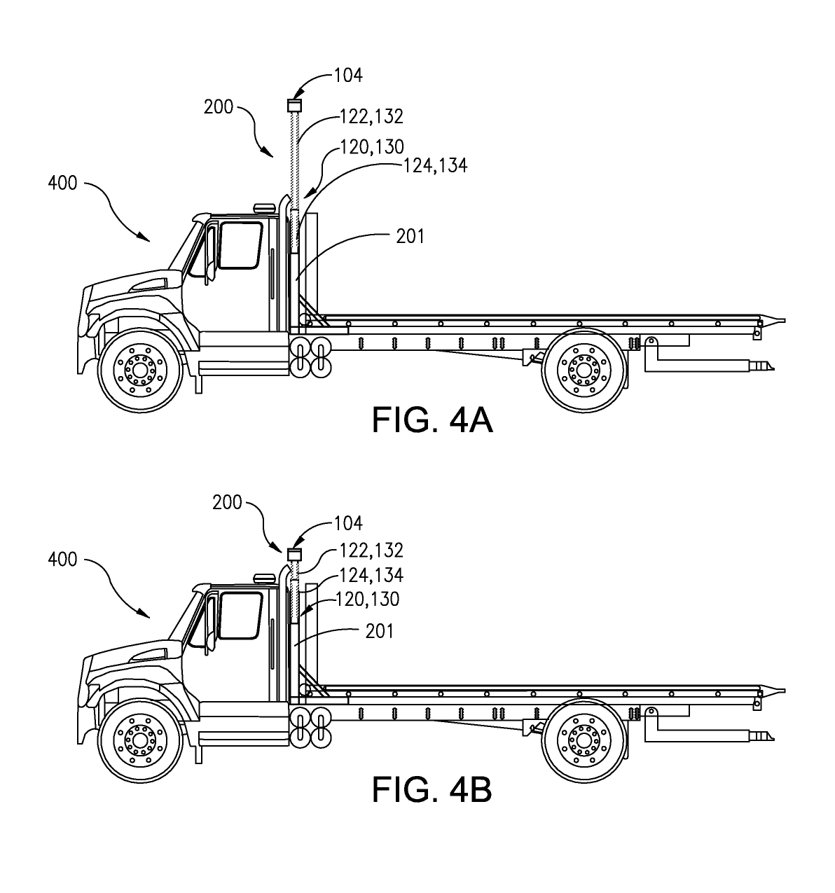

FIGS. 4A and 4B illustrate the system 200, in elevated and lowered states respectively, installed on a flatbed style tow truck 400. In this illustration, the base 202 of frame 201 is coupled to the stationary under-bed or rails (not shown in detail) that are part of the frame or chassis of the truck (not shown in detail), and not to the bed that is capable of being inclined to the ground to receive the vehicle to be towed.

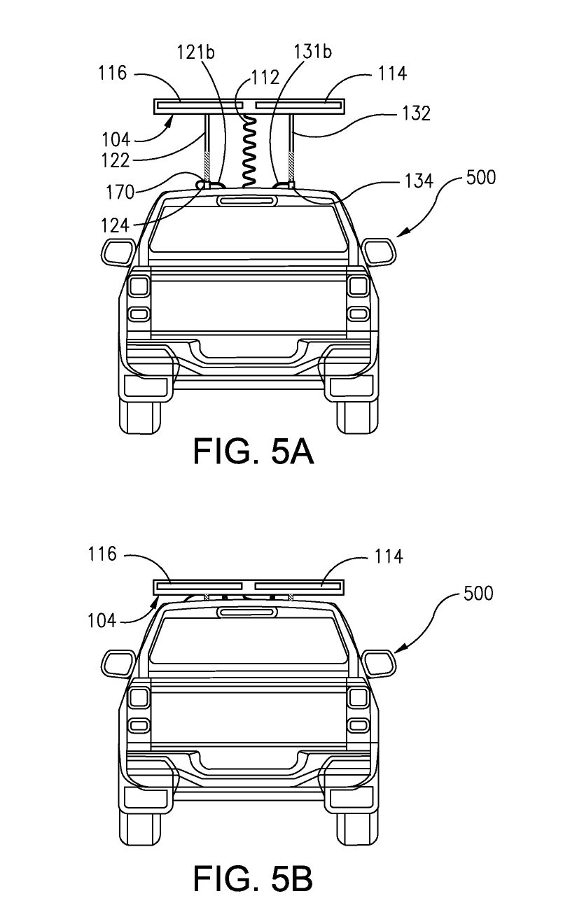

In some embodiments, cylinders 124, 134 of actuators 120, 130 may be mounted directly to the frame, chassis or other sturdy portion of a vehicle 10 to allow for secure elevation of lightbar assembly 104. In other embodiments, such as is shown in FIGS. 5A and 5B, cylinders 124, 134 of actuators 120, 130 are secured internally to pickup truck 500. In such embodiments, cylinders 124, 134 of actuators 120, 130 may be mounted directly to the back-wall of an extended cab, or may be mounted using a smaller support frame (not shown) coupled to the floor of the cab, so that the rods 122, 132 can extend out through the roof of the cab as illustrated.

As previously mentioned, in various embodiments, lightbar assembly 104 may be elevated from a few inches to ten feet or more above the cab of a vehicle having an elevatable lightbar system 100 installed therein. The range of elevation can be varied depending upon the particular application. The size and weight of lightbar assembly 104 (including lightbars 114, 116 and any other devices mounted thereto), and the desired maximum elevation of lightbar assembly 104 will dictate the appropriate size and type of the fluid actuators to be used. The fluid actuators 120, 130 shown in FIGS. 1-5 are single-stage hydraulic cylinders. In some embodiments, fluid actuators may be multi-stage hydraulic or pneumatic cylinders, depending on the type of and size of the vehicle, the desired elevation height, and the overall application. For example, as the vehicle gets larger, the lightbar assembly used for that vehicle may get larger, and thus the size and types of fluid actuators and the size of the frame used to support them may be scaled accordingly.

In addition to any previously indicated modification, numerous other variations and alternative arrangements may be devised by those skilled in the art without departing from the spirit and scope of this description, and appended claims are intended to cover such modifications and arrangements.

What is claimed is:

1. A linearly actuated elevatable/lowerable lightbar system for vehicles, the system comprising:
a lightbar assembly;
a linear actuating means for elevating the light bar assembly, and for lowering the light bar assembly once elevated, the linear actuating means including:
at least one rod having a first end coupled to the light bar assembly, and having a second end; and
a controlling means for exerting an elevating force on the second end of the at least one rod to elevate the at least one rod and the lightbar assembly coupled thereto, the controlling means being further for removing the elevating force so as to lower the at least one rod and thereby lower the light bar assembly coupled thereto.

2. The lightbar system of claim 1, further comprising a frame for rigidly supporting the lightbar system at a first end of the frame, the frame capable of being supportably secured to a vehicle at a second end of the frame.

3. The lightbar system of claim 2, wherein the frame has a base at the second end that is capable of being secured to a bed of the vehicle.

4. The lightbar system of claim 1, wherein the linear actuating means is a fluid actuator.

5. The lightbar system of claim 4, wherein the fluid actuator includes a hydraulic cylinder, and the controlling means includes a hydraulic pump.

6. The lightbar system of claim 4, wherein the fluid actuator is a pneumatic cylinder and the controlling means includes an air compressor.

7. The lightbar system of claim 4, wherein the fluid actuator is a double action actuator.

8. The lightbar system of claim 1, wherein the linear actuating means is a mechanical actuator.

9. The lightbar system of claim 8, wherein the mechanical actuator is a set screw and the controlling means includes an electric motor.

10. The lightbar system of claim 1, further comprising a contact sensor to indicate whether the lightbar assembly is in an elevated position.

11. A linearly actuated elevatable/lowerable lightbar system for vehicles, the system comprising:
a lightbar assembly;
a fluid actuator capable of elevating and lowering the light bar assembly, the fluid actuator having at least one rod having a first end coupled to the light bar assembly, and having a second end;
a fluid controller capable of exerting an elevating force on the second end of the at least one rod to elevate the at least one rod and the lightbar assembly attached thereto, the fluid controller being further capable of removing the extending force to lower the at least one rod so as to lower the light bar assembly once extended; and
a frame for rigidly supporting the lightbar system attached at a first end of the frame, the frame having a second end capable of being supportably secured to a vehicle.

12. The lightbar system of claim 11, wherein the second end of the frame has a base that is capable of being secured to a bed of the vehicle.

13. The lightbar system of claim 11, wherein the fluid actuator is a hydraulic cylinder and the fluid controller includes a hydraulic pump.

14. The lightbar system of claim 11, wherein the fluid actuator is a double acting hydraulic cylinder.

15. The lightbar system of claim 11, further comprising a contact sensor to indicate whether the lightbar assembly is in an elevated position.

16. The lightbar system of claim 15, further comprising a control panel for controlling how far the lightbar assembly is elevated, and for controlling functioning of the lightbar assembly.

17. The lightbar system of claim 16, further comprising:
an operator warning indicator located in the control panel that receives a signal from the contact sensor when the lightbar is in an elevated position.

18. The lightbar system of claim 11, wherein the frame supportably couples the lightbar assembly to at least one vehicle frame rail.

19. The lightbar system of claim 11, wherein the frame is configured to mount the lightbar assembly between the cab and the bed of a vehicle.

20. The lightbar system of claim 11, further comprising a mechanical actuator coupled to the lightbar assembly that can be used to raise and lower the lightbar assembly if the fluid actuator and/or the fluid controller fails.
